(19) United States
(12) Patent Application Publication
(10) Pub. No.: US 2021/0153476 A1
(43) Pub. Date: May 27, 2021

(54) ANIMAL HARNESS

(71) Applicant: Barb Richards, Naperville, IL (US)

(72) Inventor: Barb Richards, Naperville, IL (US)

(21) Appl. No.: 16/698,390

(22) Filed: Nov. 27, 2019

(51) Int. Cl. A01K 27/00

(52) U.S. Cl. CPC A01K 27/002

(57) ABSTRACT

An animal harness may allow a user to support a disabled animal in an upright position during walking, physical therapy, or other activities. The animal harness may comprise a saddle which further includes two ratcheting devices, a handle attached to the top of saddle, two retraction mechanisms each coupled to a corresponding ratcheting device, and two straps, wherein one end of each strap may be attached to the saddle and the opposing end of each strap may be coupled to a corresponding ratcheting device such that each strap forms an adjustable loop configured to fit around the limb of an animal. Each strap may be removable from the harness. The handle and each ratcheting device may be removable from the saddle. The user may remove the handle from the saddle by engaging a release mechanism coupled to the handle. The handle may be rotatable. The saddle may include a cushion.

### BACKGROUND OF THE INVENTION

### 1. Technical Field

Over 80 million households in the United States (about 68 percent of U.S. households) own at least one pet. About 60 million of these households own at least one dog and about 47 million of these households own at least one cat. As pets are increasingly being considered part of the family, pet owners (or “pet parents” as many call themselves) are willing to spend large amounts of money to keep their pets healthy and happy, sometimes spending more on their pet's health than their own.

In previous eras, owners of pets with severe illnesses and disabilities often made the choice to let nature take its course—expending little, if any, time and money in attempting to treat a severely ill or injured pet. In 2016 alone, however, pet owners spent just over $40 billion on health supplies, over-the-counter medicine, and vet care for their pets, demonstrating just how precious and irreplaceable pets have become to their owners.

Just like humans, animals may experience a number of debilitating injuries and illnesses that substantially affect their quality of life (and the lives of their owners). For example, being hit by a car is one of the most common accidents that causes major physical trauma in dogs, and may result in bone fractures, joint dislocation, spinal injury, and/or paralysis, all of which can severely affect a dog's mobility and quality of life. Another common injury in dogs is cruciate ligament injury, e.g., an ACL tear, which often leads to knee pain and instability.

Decreased mobility and/or paralysis in dogs and cats may also result from diseases such as arthritis, intervertebral disk disease, degenerative lumbosacral stenosis, or fibrocartilaginous embolism (spinal stroke) caused by pieces of cartilage blocking blood flow in the spinal cord. These diseases may lead to sudden and unexpected loss of mobility and control in an animal's limbs.

Injuries and illnesses that cause pain, decreased mobility, and/or paralysis in animals may render the animal unable to perform basic necessary functions such as getting up to eat, drink, and go to the bathroom. If the impaired limb or limbs are one or more front limbs, the animal may not be able to move themselves at all. If the animal's impaired limb or limbs are one or more hind limbs, the animal may have to drag their hind limbs on the ground behind them while they use their front limbs to propel themselves forward. This, however, may be exceedingly difficult for the animal and may cause pain, irritation, and further injury to the animal's limbs. Further, if the animal's hind limbs are impaired, they may get urine and excrement on their limbs while going to the bathroom.

The owners of these disabled pets may have difficulty lifting and/or moving their animals, especially larger animals, to assist them in performing these functions. As a result, these animals may become dehydrated and malnourished and have frequent accidents inside the home. Owners must constantly spend time, money, and energy cleaning their animal's messes, and the dehydration and lack of proper nutrition may lead to more vet and health expenses, worsening of the injury or underlying illness, and a more rapid decline. Further, the owners themselves may develop injuries from having to constantly bend over, lift, and/or carry their disabled animals.

Physical therapy can sometimes improve pain, mobility, and even paralysis in animals. For example, if the animal has some mobility in their limbs or if the animal suffers from partial paralysis caused by a neurological disorder such as a fibrocartilaginous embolism, their diminished mobility may be bolstered by physical therapy. For some of the physical therapy exercises to be effective, however, the animal may need to be positioned upright.

One issue with physical therapy in disabled animals is that, while the animal may technically have some mobility in the limb, they may not have the strength to support themselves upright. Because these animals can't support themselves upright, they may not be able to perform physical therapy exercises that might otherwise provide substantial benefit and improvement to their mobility.

### 2. Related Art

Prior art animal harnesses, including harnesses used for assisting animals in walking, are often bulky and uncomfortable for the animal wearing them and difficult for the owner to use and adjust. In addition, some prior art harnesses have straps that are too thin and wrap tightly around the animals legs causing pain, irritation, and restricted blood flow to the limbs. Further, these prior art harnesses are not adapted for easy transport and storage.

Accordingly, a need has long existed for an improved animal harness.

### SUMMARY

An animal harness according to the claimed invention may allow a user to support a disabled animal in an upright position while the animal is walking, undergoing physical therapy, performing other activities, or the like. The animal harness may comprise a saddle which further includes two ratcheting devices, a handle disposed on top of the saddle, two retraction mechanisms each coupled to a corresponding ratcheting device, and two straps, wherein one end of each strap may be attached to the saddle and the opposing end of each strap may be coupled to a corresponding ratcheting device such that each strap forms an adjustable loop configured to fit around the limb of an animal.

Each strap may be removable from the saddle and corresponding ratcheting device. The handle and each ratcheting device may be removable from the saddle. The user may remove the handle from the saddle by engaging a release mechanism coupled to the handle. The handle may be rotatable. The saddle may include a cushion disposed on or near the bottom of the saddle to provide comfort and prevent irritation to the animal during use.

Other systems, methods, features, and technical advantages of the invention will be, or will become apparent to one with skill in the art upon examination of the following figures and detailed description. It is intended that all such additional systems, methods, features, and technical advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a front perspective view of an exemplary animal harness. The dashed lines in FIG. 1 represent components of the harness that are embedded within the saddle. The longdash lines in FIG. 1 represent axes of the harness.

FIG. 2 is a left perspective view of a dog wearing the exemplary animal harness of FIG. 1. The longdash line of FIG. 2 represents an axis of the harness.

### DETAILED DESCRIPTION OF THE DRAWINGS

1.0 Animal Harness Overview

Structure and Function

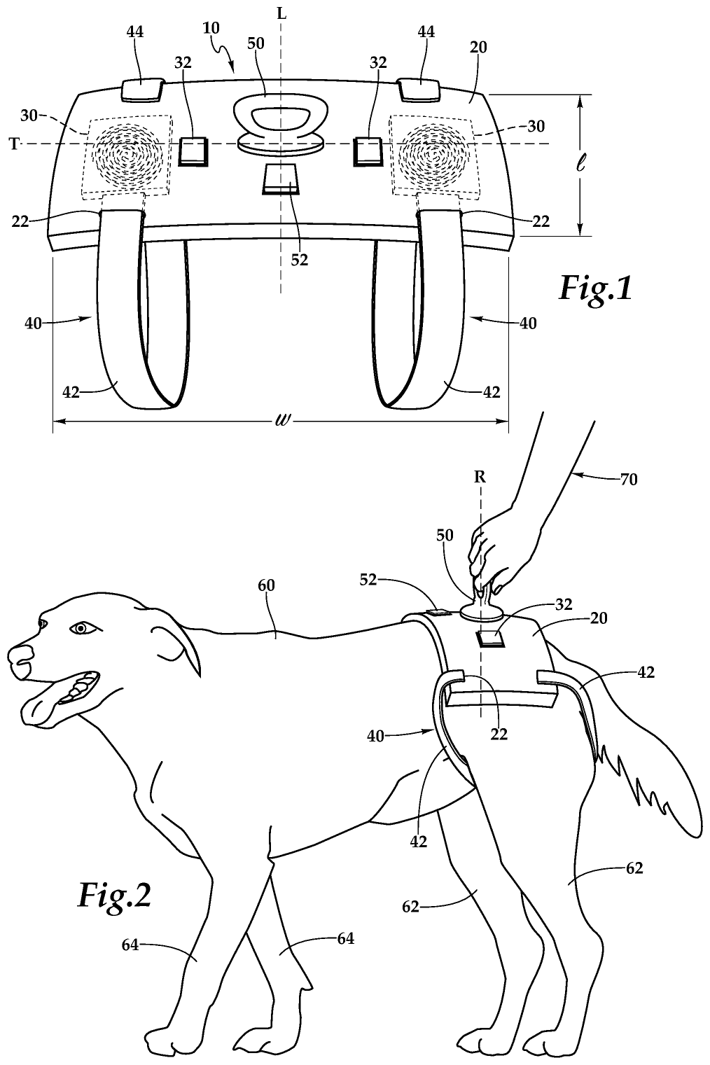

Referring to the drawings and initially to FIG. 1, a front perspective view of an exemplary animal harness 10 is shown. Harness 10 may comprise a saddle 20 further including two ratcheting devices 30, a handle 50 disposed on saddle 20, two retraction mechanisms 32 each disposed on saddle 20 and coupled to a corresponding ratcheting device 30, and two straps 42, wherein one end 44 of each strap 42 is attached to saddle 20 and the opposing end of each strap 42 is coupled to a corresponding ratcheting device 30 such that each strap 42 forms an adjustable loop 40 configured to fit around a limb of an animal. Saddle 20 may be configured to rest on the back of an animal.

Referring again to FIG. 1, each loop 40 may be enlarged by extending corresponding strap 42 outward from corresponding ratcheting device 30. Each corresponding strap 42 may be extended from corresponding ratcheting device 30 by the user directly pulling each corresponding strap 42 outward from corresponding ratcheting device 30 or by the user lifting saddle 20 via handle 50, thereby causing each corresponding strap 42 to extend from corresponding ratcheting device 30.

For example, each loop 40 may be enlarged by the user directly pulling each corresponding strap 42 outward from corresponding ratcheting device 30. When corresponding loop 40 is large enough, for example, to receive a limb of the animal, the user may stop directly applying the outward pulling force to strap 42, which may cause corresponding ratcheting device 30 to substantially lock into place, thereby fixing the size of corresponding loop 40.

Each loop 40 may also be enlarged by the user lifting saddle 20 via handle 50. The upward lifting force may cause each corresponding strap 42 to extend from corresponding ratcheting device 30, thereby allowing the user to raise saddle 20 to a height comfortable for the user. For example, the user may lift saddle 20 to a height where the user does not have to bend down when walking the animal wearing harness 10.

The size of each loop 40 may be reduced by retracting corresponding strap 42 back into corresponding ratcheting device 30. Each corresponding strap may be retracted into corresponding ratcheting device 30 by engaging corresponding retraction mechanism 32. When corresponding retraction mechanism 32 is disengaged, corresponding ratcheting device 30 may lock into place, thereby fixing the size of corresponding loop 40.

Exemplary Use

In an exemplary use of harness 10, the user may pull each strap 42 outward from corresponding ratcheting device 30 to form loops 40. The amount of each strap 42 pulled from corresponding ratcheting device 30 may be such that each resulting loop 40 is large enough to receive a limb of an animal. The user may then place saddle 20 on the animal's back and insert one of the animal's limbs through each corresponding loop 40.

The user may secure each loop 40 around the corresponding limb by engaging corresponding retraction mechanism 32, whereby corresponding retraction mechanism 32 may cause strap 42 to retract back into corresponding ratcheting device 30, the result being that each loop 40 is adjusted to fit comfortably and securely around the animal's limb, as shown in FIG. 2.

As shown in FIG. 2, one or both of hind limbs 62 of animal 60 may be impaired. As such, saddle 20 may be positioned across the width of the back of animal 60 proximate hind limbs 62, as shown in FIG. 2. Each hind limb 62 may be inserted into a corresponding loop 40. Each corresponding loop 40 may then be adjusted to fit comfortably and securely around each corresponding hind limb 62.

Additionally or alternatively, harness 10 may be adjustable for user comfort as well as animal comfort. For example, each corresponding loop 40 may be further adjusted to allow saddle 20 to be raised and lowered to a comfortable height for user 70. Each corresponding loop 40 may be enlarged by user 70 directly pulling corresponding strap 42 outward or by user 70 lifting saddle 10 via handle 50. The substantially outward pulling force or the substantially upward lifting force may cause each strap 42 to extend from corresponding ratcheting device 30, thereby allowing user 70 to raise saddle 20 to a height comfortable for user 70 while user 70 is upright, for example, while user 70 is standing, walking, or running with animal 60. As such, user 70 may not have to bend over to use harness 10, which may allow user 70 to avoid pain and injury to the back.

If user 70 wants to crouch, for example, to assist animal 60 in relieving their bladder, user 70 may retract each strap 42 into corresponding ratcheting devices 30 by engaging corresponding retraction mechanisms 32, thereby causing saddle 20 to lower in height.

When user 70 resumes an upright position, user 70 may again directly pull each corresponding strap 42 substantially outward or lift saddle 20 via handle 50, thereby extending each corresponding strap 42 from corresponding ratcheting device 30 and raising saddle 20 to a comfortable height for user 70. Accordingly, harness 10 may be adjustable to accommodate for the user's height and comfort.

As shown in FIG. 2, user 70 may provide upright support to animal 60 by lifting harness 10 via handle 50. Because user 70 is providing support to hind limbs 62 of animal 60 by lifting harness 10, animal 60 can be positioned upright even if hind limbs 62 are not able to support animal 60. Thus, if the animal's other limbs remain unimpaired, such as front limbs 64 in FIG. 2, animal 60 may use the unimpaired limbs to propel themselves forward during walking.

With help from user 70, animal 60 may therefore be able to walk outside to use the bathroom without having to drag their impaired hind limbs 62 on the ground. Further, because animal 60 can be supported upright while using the bathroom, less urine and/or excrement may get on animal 60 and hind limbs 62 while animal 60 is using the bathroom.

Additionally or alternatively, harness 10 may be used for physical therapy. Harness 10 may be beneficial for use in physical therapy by allowing animal 60 to be supported upright, which may broaden the type of exercises animal 60 is able to perform.

User 70 may provide a majority of the support that may otherwise be provided by hind limbs 62. As such, if hind limbs 62 have some mobility, even if that mobility is limited, the support from user 70 and harness 10 may allow hind limbs 62 to freely perform a walking motion without hind limbs 62 also having to support the weight of animal 60.

With the help and support of user 70 and harness 10, animal 60 may be able to practice the walking motion on a regular basis, which may gradually result in animal 60 regaining strength and mobility in impaired hind limbs 62. As physical therapy utilizing harness 10 progresses, user 70 may provide less and less support to animal 60 as animal 60 regains strength and mobility in impaired hind limbs 62. In this way, harness 10 may be a beneficial tool for physical therapy to improve strength and mobility in disabled animals.

Harness 10 may be removed from animal 60 once use of harness 10 is completed. To remove harness 10 from animal 60, user 70 may pull each strap 42 outward from corresponding ratcheting device 30, remove the hind limbs 62 from each corresponding loop 40, remove saddle 20 from the back of animal 60, and fully remove harness 10 from animal 60. User 70 may then substantially retract straps 42 back into corresponding ratcheting devices 30 for easy storage.

It is to be understood that the steps recited above are exemplary in nature and are not limited to any particular order. For example, the user may insert one hind limb 62 of the animal into a loop 40 before placing saddle 20 on the animal's back, or the user may insert both hind limbs 62 of the animal 60 into each corresponding loop 40 before placing saddle 20 on the animal's back.

Further, although FIG. 2 shows harness 10 being used with hind limbs 62 of animal 60, it is to be understood that harness 10 may be used with any limb or combination of limbs. For example, harness 10 may be used to support one or more hind limbs of an animal, one or more front limbs of an animal, or a combination of one or more front and one or more hind limbs of the animal. Harness 10 may also be configured for use with all limbs of the animal.

2.0 Saddle

Structure and Function

As shown in FIG. 1, harness 10 may include a saddle 20. As shown in FIG. 2, saddle 20 may be configured to rest on the back of an animal 60. Saddle 20 may be configured to rest anywhere along the back of the animal. For example, saddle 20 may be configured to rest on the back of animal 60 proximate the animal's hind legs 62, as shown in FIG. 2, or saddle 20 may be configured to rest on the back of an animal proximate the animal's front legs.

Saddle 20 may be configured to rest on the back of the animal in any orientation. For example, as shown in FIG. 2, saddle 20 may be configured to rest on the animal's back such that the width of saddle 20 is substantially parallel to the width of the animal's back. Additionally or alternatively, saddle 20 may be configured to rest on the animal's back such that the width of saddle 20 is substantially perpendicular to the width of the animal's back. Additionally or alternatively, saddle 20 may be configured to rest on the animal's back such that saddle 20 is positioned substantially diagonally on the animal's back.

Saddle 20 may be flexible, rigid, or semi-flexible and/or semi-rigid. Saddle 20 may be flexible enough to form to the shape of the back of animal 60, as shown in FIG. 2, while also being rigid enough to provide support to animal 60 while animal 60 is wearing harness 10. Saddle 20 may comprise natural materials such as leather, synthetic materials such as nylon or polyester, any other suitable types of materials, or a combination of suitable materials. Saddle 20 may be washable and may be made at least partially of washable material.

Returning to FIG. 1, saddle 20 may be adapted to include one or more ratcheting devices 30. For example, saddle 20 may have internal pockets adapted to accommodate at least part of a ratcheting device 30. As shown in FIG. 1, saddle 20 may further include one or more openings 22 configured to receive a corresponding strap 42, such that corresponding strap 42 may be inserted into opening 22 and coupled to corresponding ratcheting device 30, which may be at least partially embedded in saddle 20.

Saddle 20 may further include one or more cushions. The one or more cushions may be disposed at or near the bottom of the saddle and may be adapted to provide comfort to the animal during use. The cushion may be disposed across a substantial portion of the bottom of saddle 20. Additionally or alternatively, one or more cushions may be disposed across one or more smaller portions of the bottom of saddle 20. For example, one or more cushions may be disposed at or near areas of the bottom of saddle 20 that exert pressure on the animal.

In addition to providing comfort, the cushion may prevent chafing, scratching, or other irritation that saddle 20 may otherwise cause to the animal's back. The cushion may comprise gel, foam, any other suitable cushioning material, or a combination of suitable cushioning materials.

Axes

As shown in FIG. 1, saddle 20 may have a width (w). The width of saddle 20 may run substantially parallel to the width of the animal's back, which generally may be measured as the distance between the left side and the right side of the animal's back.

As also shown in FIG. 1, saddle 20 may have a length (e). The length of saddle 20 may run substantially parallel to the length of the animal, which generally may be measured as the distance between the base of the neck and the base of the tail.

As shown in FIG. 1, harness 10 may be defined by a transverse axis (T) that runs parallel to the width of saddle 20 and a longitudinal axis (L) that runs parallel to the length of saddle 20 The longitudinal axis may be substantially perpendicular to the transverse axis. The longitudinal axis and transverse axis may form a plane, referred to herein as “the saddle plane.”

As shown in FIG. 2, harness 10 may further be defined by a rotation axis (R) disposed substantially normal to the saddle plane. Handle 50 may be positioned on saddle 20 such that handle 50 may rotate about the rotation axis R.

Dimensions

As described above, saddle 20 may have a width and a length. Saddle 20 may also have a thickness. Generally, saddle 20 may have a width of between about 4½ inches and about 15½ inches, a length of between about 3½ inches and about 8½ inches, and a thickness of between about ¼ inches and about 1¾ inches.

Saddle 20 may be adapted to fit various sizes of animals. For example, the width, length, and thickness of saddle 20 may be adapted to fit small, medium, or large animals. Generally, smaller animals may require smaller saddles and larger animals may require larger saddles.

Small Size

For example, in a small size, saddle 20 may be adapted to fit smaller animals, including, but not limited to, cats, puppies, and smaller dog breeds such as small terriers, dachshunds, pugs, shih tzus, and beagles. In said small size, saddle 20 may have a width of between about 4½ inches and about 8½ inches. Preferably, saddle 20 may have a width of between about 5½ inches and about 7½ inches. More preferably, saddle 20 may have a width of between about 6 inches and about 7 inches. In said small size, saddle 20 may have a width of about 6½ inches.

In said small size, saddle 20 may have a length of between about 3½ inches and about 6½ inches. Preferably, saddle 20 may have a length of between about 4 inches and about 6 inches. More preferably, saddle 20 may have a length of between about 4½ inches and about 5½ inches. In said small size, saddle 20 may have a length of about 5 inches.

In said small size, saddle 20 may have a thickness of between about ¼ inch and about 1¾ inches. Preferably, saddle 20 may have a thickness of between about ½ inch and about 1½ inches. More preferably, saddle 20 may have a thickness of between about ¾ inches and about 1¼ inches. In said small size, saddle 20 may have a thickness of about 1 inch.

Medium Size

In an exemplary medium size, saddle 20 may be adapted to fit medium animals, including, but not limited to, medium dog breeds such as boxers, bulldogs, collies, retrievers, poodles, and certain hound breeds. In said medium size, saddle 20 may have a width of between about 8½ inches and about 111/2 inches. Preferably, saddle 20 may have a width of between about 9 inches and about 11 inches. More preferably, saddle 20 may have a width between about 9½ inches and about 10½ inches. In said medium size, saddle 20 may have a width of about 10 inches.

In said medium size, saddle 20 may have a length of between about 4½ inches and about 7½ inches. Preferably, saddle 20 may have a length between about 5 inches and about 7 inches. More preferably, saddle 20 may have a length of between about 5½ inches and about 6½ inches. In said medium size, saddle 20 may have a length of about 6 inches.

In said medium size, saddle 20 may have a thickness of between about ¼ inch and about 1¾ inches. Preferably, saddle 20 may have a thickness of between about ½ inch and about 1½ inches. More preferably, saddle 20 may have a thickness of between about ¾ inch and about 1¼ inches. In said medium size, saddle 20 may have a thickness of about 1 inch.

Large Size

In an exemplary large size, saddle 20 may be adapted to fit large animals, including, but not limited to, large dog breeds such as mastiffs, great danes, dobermans, and saint bernards. In said large size, saddle 20 may have a width of between about 11½ inches and about 15½ inches. Preferably, saddle 20 may have a width of between about 12½ inches and about 14½ inches. More preferably, saddle 20 may have a width of between about 13 inches and about 14 inches. In said large size, saddle 20 may have a width of about 131/2 inches.

In said large size, saddle 20 may have a length of between about 5½ inches and about 8½ inches. Preferably, saddle 20 may have a length of between about 6 inches and about 8 inches. More preferably, saddle 20 may have a length of between about 6½ inches and about 7½ inches. In said large size, saddle 20 may have a length of about 7 inches.

In said large size, saddle 20 may have a thickness of between about ¼ inch and about 1¾ inches. Preferably, saddle 20 may have a thickness of between about ½ inch and about 1½ inches. More preferably, saddle 20 may have a thickness of between about ¾ inch and about 1¼ inches. In said large size, saddle 20 may have a thickness of about 1 inch.

It is to be understood that the dimensions of saddle 20 are not limited to the dimensions recited above. The dimensions of saddle 20 may be larger or smaller than those recited above. For example, saddle 20 may be adapted to fit smaller animals than those recited above, such as mice, lizards, or rabbits. Saddle 20 may also be adapted to fit larger animals than those recited above, such as tigers, horses, or elephants.

Further, the saddle sizes recited above are not limited to any particular size of animal. For example, a medium sized saddle could be used on a large animal or a large sized saddle could be used on a medium animal.

Further, the width, length, and thicknesses recited above for each size of saddle are not limited to that specific size of saddle. For example, a saddle 20 may have a width recited above for a large size, a length recited above for a medium size, and a thickness recited above for a small size.

3.0 Ratcheting Devices

Structure and Function

As shown in FIG. 1, harness 10 may include one or more ratcheting devices 30. As shown in FIG. 1, harness 10 may include two ratcheting devices 30. Ratcheting devices 30 may be disposed on saddle 20, may be at least partially embedded in saddle 20, or, as shown in FIG. 1, may be fully embedded in saddle 20. As shown in FIG. 1, each ratcheting device 30 may be disposed proximate an opposing end of saddle 20.

As shown in FIG. 1, ratcheting devices 30 may be coupled to corresponding straps 42. Each ratcheting device 30 may be configured to extend corresponding strap 42 from corresponding ratcheting device 30 and retract corresponding strap 42 from corresponding ratcheting device 30. Each ratcheting device may be configured to releasably lock each corresponding strap 42.

Each ratcheting device 30 may comprise a wheel around which a corresponding strap 42 is wrapped. When a user directly pulls strap 42 or when a user lifts saddle 20, ratcheting device 30 may allow corresponding strap 42 to unwind from the ratcheting wheel, thereby increasing the amount of corresponding strap 42 extended from ratcheting device 30.

Once the user ceases to directly pull corresponding strap 42 substantially outward or lift saddle 20 substantially upward, ratcheting device 30 may lock into place, thereby fixing the amount of corresponding strap 42 extended from ratcheting device 30, and hence fixing the size of corresponding loop 40.

The user may retract each corresponding strap 42 back into the ratcheting device 30 by engaging a corresponding retraction mechanism 32 coupled to ratcheting device 30. Retraction mechanisms 32 may comprise any suitable mechanism that causes the corresponding ratcheting devices 30 to retract corresponding straps 42 back into corresponding ratcheting device 30. For example, each retraction mechanism 32 may be a button, a switch, a buckle, or the like.

Corresponding retraction mechanism 32 may unlock a locked ratcheting device 30, causing the ratcheting wheel to rewind corresponding strap 42 back around the ratcheting wheel, and hence retracting corresponding strap 42 back into corresponding ratcheting device 30. Ratcheting device 30 may lock again when the user disengages corresponding retraction mechanism 32, again fixing the amount of strap 42 extended from ratcheting device 30.

The ratcheting devices 30 and corresponding retraction mechanisms 32 may therefore allow the user to adjust each corresponding strap 42 individually such that each strap 42 may fit comfortably around the corresponding limb and/or such that saddle 20 may be positioned at a height comfortable for the user.

The ratcheting devices 30 and corresponding retraction mechanisms 32 may lock each corresponding strap 42 into place once each strap 42 is adjusted to fit comfortably around the corresponding limb, thereby preventing each strap 42 from digging into the animal's limb and causing pain, irritation, and/or restriction of blood flow.

Additionally or alternatively, the ratcheting devices 30 and corresponding retraction mechanisms 32 may lock each corresponding strap 42 into place once saddle 20 is positioned at a height comfortable for the user.

In this way, a user may lengthen and retract corresponding straps 42 via the ratcheting device 30 so that corresponding straps 42, which form corresponding loops 40, can be placed around a corresponding limb of the animal and adjusted to fit around the corresponding limb comfortably and securely and/or adjusted to position saddle 20 add a height comfortable for the user.

4.0 Straps

Structure and Function

As shown in FIG. 1, harness 10 may include one or more straps 42. As shown in FIG. 1, one end 44 of each strap 42 may be attached to saddle 20 and an opposing end of each strap 42 may be coupled to a corresponding ratcheting device 30. The end 44 of each strap 42 attached to saddle 20 may be fixed to saddle 20, for example, via stitching, or may be removably attached to saddle 20 such that strap 42 may be removed from harness 10. For example, end 44 of each strap 42 may be removably attached to saddle 20 via a hook-and-loop fastener such as Velcro® manufactured by Velcro BVBA, snap buttons, or any other suitable removable attachment mechanism.

As harness 10 may get dirty from use, for example, when the animal is going to the bathroom, straps 42 may need to be cleaned from time to time. As such, each strap 42 may be removable from harness 10. Each strap 42 may be removed from harness 10 by detaching one end 44 of each strap 42 from saddle 20 and uncoupling the opposing end of each strap 42 from corresponding ratcheting device 30. Each strap 42 may be integrated or reintegrated into harness 10 by attaching one end 44 of each strap 42 to saddle 20 and coupling the opposing end of each strap 42 to a corresponding ratcheting device 30. If corresponding ratcheting device 30 is embedded at least partially within saddle 20, each strap 42 may be inserted through a corresponding opening 22 in saddle 20 and coupled to corresponding ratcheting device 30.

Straps 42 may be made of any suitable strapping material, such as nylon webbing or the like. Each strap 42 may be made of material suitable for coupling strap 42 with a corresponding ratcheting device 30. For example, each strap 42 may have a thickness suitable for compactly wrapping strap 42 around a ratcheting wheel. Each strap 42 may be made of material that is non-irritating to an animal's skin and may include padding or cushioning for added comfort. Each strap 42 may be washable and may be at least partly made of washable material.

Dimensions

Each strap 42 may have a length, a width, and a thickness. Generally, each strap may have a length of between about 2 ft. and about 4 ft., a width of between about ¼ inches and about 2 inches, and a thickness of between about 1/40 inches and about 3/40 inches.

Each strap 42 may have a width large enough such that strap 42 does not dig into the animal's limb, thereby causing pain, irritation, constricted blood flow, and/or worsening of the injury or illness.

Further, each strap 42 may be adapted to fit various sizes of animals. For example, each strap 42 may be adapted to fit small, medium, or large animals. Generally, larger animals may require longer straps.

Small Size

For example, in a small size, each strap 42 may be adapted to fit smaller animals, including, but not limited to cats, puppies, and smaller dog breeds such as small terriers, dachshunds, pugs, shih tzus, and beagles. In said small size, each strap 42 may have a length of between about 2 ft. and about 3 ft. Preferably, each strap may have a length of between about 2¼ ft. and about 2¾ ft. In a small size, each strap 42 may have a length of about 2½ ft.

In said small size, each strap 42 may have a width of between about ¼ inches and about 1½ inches. Preferably, each strap may have a width of between about ½ inch and about 1¼ inches. More preferably, each strap may have a width of between about ¾ inch and about 1 inch. In said small size, each strap 42 may have a width of about ¾ inch.

In said small size, each strap 42 may have a thickness of between about 1/40 inch and about 3/40 inch. Preferably, each strap may have a thickness of between about 1/32 inch and about 1/16 inch. More preferably, each strap may have a thickness of between about 1/25 inch and about 1/20 inch. In said small size, each strap 42 may have a thickness of about 1/20 inch.

Medium Size

In an exemplary medium size, each strap 42 may be adapted to fit medium animals, including, but not limited to, medium dog breeds such as boxers, bulldogs, collies, retrievers, poodles, and certain hound breeds. In said medium size, each strap 42 may have a length of between about 2½ ft. and about 3½ ft. Preferably, each strap may have a length of between about 2¾ ft. and about 3¼ ft. In said medium size, each strap 42 may have a length of about 3 ft.

In said medium size, each strap 42 may have a width of between about ¼ inch and about 2 inches. Preferably, each strap 42 may have a width of between about ½ inch and about 1¾ inches. More preferably, each strap 42 may have a width of between about ¾ inch and about 1½ inches. In said medium size, each strap 42 may have a width of about 1 inch.

In said medium size, each strap 42 may have a thickness of between about 1/40 inch and about 3/40 inch. Preferably, each strap may have a thickness of between about 1/32 inch and about 1/16 inch. More preferably, each strap may have a thickness of between about 1/25 inch and about 1/20 inch. In said small size, each strap 42 may have a thickness of about 1/20 inch.

Large Size

In an exemplary large size, each strap 42 may be adapted to fit large animals, including, but not limited to, large dog breeds such as mastiffs, great danes, dobermans, and saint bernards. In said large size, each strap 42 may have a length of between about 2½ ft. and about 4 ft. Preferably, each strap 42 may have a length of between about 2¾ ft. and about 3¾ ft. In said large size, each strap 42 may have a length of about 3¼ ft.

In said large size, each strap 42 may have a width of between about ¼ inch and about 2 inches. Preferably, each strap 42 may have a width of between about ½ inch and about 1¾ inches. More preferably, each strap 42 may have a width of between about ¾ inch and about 1½ inches. In said large size, each strap may have a width of about 1 inch.

In said large size, each strap 42 may have a thickness of between about 1/40 inch and about 3/40 inch. Preferably, each strap may have a thickness of between about 1/32 inch and about 1/16 inch. More preferably, each strap may have a thickness of between about 1/25 inch and about 1/20 inch. In said small size, each strap 42 may have a thickness of about 1/20 inch.

It is to be understood that the dimensions of each strap 42 are not limited to the dimensions recited above. The dimensions of each strap 42 may be larger or smaller than those recited above. For example, each strap 42 may be adapted to fit smaller animals than those recited above, such as mice, lizards, or rabbits. Each strap 42 may also be adapted to fit larger animals than those recited above, such as tigers, horses, or elephants.

Further, the strap sizes recited above are not limited to any particular size of animal. For example, a medium sized strap could be used for a large animal or a large sized strap could be used for a medium animal.

Further, the width, length, and thicknesses recited above for each size of strap are not limited to that size of strap. For example, each strap 42 could have a width recited above for a large size, a length recited above for a medium size, and a thickness recited above for a small size.

5.0 Handle

Structure and Function

As shown in FIG. 1, harness 10 may include handle 50. Handle 50 may be attached to the top of saddle 20, as shown in FIG. 1. Handle 50 may be positioned at or near the center of saddle 20, as shown in FIG. 1 and FIG. 2, or may be positioned proximate a side of saddle 20. Handle 50 may be configured for a user to hold handle 50 so that the user may lift harness 10 and guide and/or provide upright support to the animal wearing harness 10.

Handle 50 may be incorporated into saddle 20, at least partially embedded in saddle 20, or attached to saddle 20. Handle 50 may be removable from saddle 20. For example, handle 50 may be removed from saddle 20 when saddle 20 is being washed or cleaned. Handle 50 may be released from saddle 20 by engaging a release mechanism, such as release mechanism 52 disposed on saddle 20, as shown in FIG. 2.

As shown in FIG. 1, handle 50 may extend upward from saddle 20. The height of handle 50 may be adjustable. As also shown in FIG. 1, handle 50 may be elongated and may run parallel to the length or width of saddle 20. Handle 50 may be attached to saddle 20 at one or more points and/or areas on saddle 20. As shown in FIG. 1, for example, handle 50 may have one attachment to saddle 20.

Handle 50 may be attached to saddle 20 at two points and/or areas on saddle 20. For example, one end of handle 50 may be attached to saddle 20 proximate one end of saddle 20 and an opposing end of handle 50 may be attached to saddle 20 at an opposing end of saddle 20 such that handle 50 stretches across saddle 20.

Handle 50 may be rotatable to adjust for the animal's lateral movements during walking. Handle 50 may be rotatable about a rotation axis disposed generally normal to the saddle plane, i.e., the plane defined by the longitudinal axis and transverse axis, as described above.

For example, handle 50 may be rotatable by between about 60 degrees and about 120 degrees in each direction about the rotation axis. Preferably, handle 50 may be rotatable by between about 70 degrees and about 110 degrees in each direction about the rotation axis. More preferably, handle 50 may be rotatable by between about 80 degrees and about 100 degrees in each direction about the rotation axis. Even more preferably, handle 50 may be rotatable by about 90 degrees in each direction about the rotation axis.

Handle 50 may be made of rigid material such as plastic, metal, wood, or the like. Additionally or alternatively, handle 50 may be made of soft and/or pliable material such as rope, nylon, webbing, rubber, or the like. Handle 50 may be made at least partially of rope. Handle 50 may further include a grip for user comfort and control. Handle 50 may also include padding or a cushion for user comfort. Said cushion may comprise gel, foam, any other suitable cushioning material, or a combination of suitable cushioning materials.

An exemplary harness for providing support to an animal may comprise a saddle having a width and a length, wherein the saddle includes two ratcheting devices; a handle disposed on top of the saddle; and two straps, one end of each strap being attached to the saddle and the opposing end of each strap being coupled to a corresponding ratcheting device, such that each strap forms an adjustable loop configured to fit around a limb of the animal, and wherein the size of each loop is adjusted by extending the corresponding strap from the corresponding ratcheting device and retracting the corresponding strap into the corresponding ratcheting device via a corresponding retraction mechanism coupled to the corresponding ratcheting device.

The ratcheting devices of the harness may be disposed on top of the saddle. The ratcheting devices of the harness may be at least partially embedded within the saddle. The ratcheting devices of the harness may be fully embedded within the saddle.

The handle of the harness may be elongated. The handle of the harness may extend upwards.

The harness may be defined by a transverse axis that runs parallel to the width of the saddle and a longitudinal axis that runs parallel to the length of the saddle, and the handle may be rotatable about a rotation axis that is generally normal to both the transverse axis and longitudinal axis.

The handle of the harness may be removably attached to the saddle. Each strap of the harness may be removable from the saddle and corresponding ratcheting device.

An exemplary animal harness for providing support to an animal may comprise a saddle having a width and length, wherein the saddle includes two ratcheting devices; a handle removably attached to the top of the saddle, wherein the handle may be rotatable about a rotation axis that is generally normal to a transverse axis running parallel to the width of the saddle and a longitudinal axis running parallel to the length of the saddle; and two straps, one end of each strap being removably attached to the saddle and the opposing end of each strap being coupled to a corresponding ratcheting device, such that each strap forms an adjustable loop configured to fit around a limb of the animal, and wherein the size of each loop is adjusted by extending the corresponding strap from the corresponding ratcheting device and retracting the corresponding strap into the corresponding ratcheting device via a corresponding retraction mechanism coupled to the corresponding ratcheting device, and wherein each strap is removable from the saddle and corresponding ratcheting device.

The ratcheting devices of the harness may be disposed on top of the saddle. The ratcheting devices of the harness may be at least partially embedded within the saddle. The ratcheting devices of the harness may be fully embedded within the saddle.

The handle of the harness may be elongated. The handle of the harness may extend upwards.

While one or more embodiments of the invention have been described, it will be apparent to those of ordinary skill in the art that many more embodiments and implementations are possible within the scope of the invention. Accordingly, the invention is not to be restricted except in light of the recited claims and their equivalents.

I claim:

1. A harness for providing support to an animal, comprising:
a saddle having a width and a length, wherein the saddle includes two ratcheting devices;
a handle disposed on top of the saddle; and
two straps, one end of each strap being attached to the saddle and the opposing end of each strap being coupled to a corresponding ratcheting device, such that each strap forms an adjustable loop configured to fit around a limb of the animal, and
wherein the size of each loop is adjusted by extending the corresponding strap from the corresponding ratcheting device and retracting the corresponding strap into the corresponding ratcheting device via a corresponding retraction mechanism coupled to the corresponding ratcheting device.

2. The harness of claim 1, wherein the ratcheting devices are disposed on top of the saddle.

3. The harness of claim 1, wherein the ratcheting devices are at least partially embedded within the saddle.

4. The harness of claim 1, wherein the ratcheting devices are fully embedded within the saddle.

5. The harness of claim 1, wherein the handle is elongated.

6. The harness of claim 1, wherein the handle extends upwards.

7. The harness of claim 1, wherein the harness is defined by a transverse axis that runs parallel to the width of the saddle and a longitudinal axis that runs parallel to the length of the saddle, and wherein the handle is rotatable about a rotation axis that is generally normal to both the transverse axis and longitudinal axis.

8. The harness of claim 1, wherein the handle is removably attached to the saddle.

9. The harness of claim 1, wherein each strap is removable from the saddle and corresponding ratcheting device.

10. A harness for providing support to an animal, comprising:
a saddle having a width and length, wherein the saddle includes two ratcheting devices;
a handle removably attached to the top of the saddle, wherein the handle may be rotatable about a rotation axis that is generally normal to a transverse axis running parallel to the width of the saddle and a longitudinal axis running parallel to the length of the saddle; and
two straps, one end of each strap being removably attached to the saddle and the opposing end of each strap being coupled to a corresponding ratcheting device, such that each strap forms an adjustable loop configured to fit around a limb of the animal, and
wherein the size of each loop is adjusted by extending the corresponding strap from the corresponding ratcheting device and retracting the corresponding strap into the corresponding ratcheting device via a corresponding retraction mechanism coupled to the corresponding ratcheting device, and wherein each strap is removable from the saddle and corresponding ratcheting device.

11. The harness of claim 10, wherein the ratcheting devices are disposed on top of the saddle.

12. The harness of claim 10, wherein the ratcheting devices are at least partially embedded within the saddle.

13. The harness of claim 10, wherein the ratcheting devices are fully embedded within the saddle.

14. The harness of claim 10, wherein the handle is elongated.

15. The harness of claim 10, wherein the handle extends upwards.
